(19) United States
(12) Patent Application Publication
(10) Pub. No.: US 2009/0131629 A1
(43) Pub. Date: May 21, 2009

(54) Polymers with pendant alkyl chains

(76) Inventor: Thomas Daly, Arlington Heights, IL (US)

Correspondence Address: CLIFFORD H. KRAFT, 320 ROBIN HILL DR., NAPERVILLE, IL, 60540, US

(21) Appl. No.: 12/290,872

(22) Filed: Nov. 3, 2008

Related U.S. Application Data
(63) Continuation-in-part of application No. 11/983,377, filed on Nov. 8, 2007.
Application No. 11/983,377 is a continuation-in-part of application No. 10/666,584, filed on Sep. 18, 2003, now abandoned.
(60) Provisional application No. 60/411,907, filed on Sep. 19, 2002.

(51) Int. Cl. C08G 69/02

(52) U.S. Cl. 528/332

(57) ABSTRACT

A hydrophobic polymer well suited for applications such as general purpose coatings, ship coatings, fibers and sheets. The present invention is particularly well suited for making breathable, yet waterproof clothing.

This application is a continuation-in-part of co-pending application Ser. No. 11/983,377 filed Nov. 8, 2007 which was a continuation-in-part of application Ser. No. 10/666,584, now abandoned, filed Sep. 18, 2003 which claimed priority from provisional patent application No. 60/411,907 filed Sep. 19, 2002. Application Ser. Nos. 11/983,377, 10/666,584 and 60/411,907 are hereby incorporated by reference.

### BACKGROUND

1. Field of the Invention

The present invention relates generally to the field of polymers and more particularly to a class of polymers with pendant alkyl chains.

2. Description of the Problem Solved by the Invention

Polymers are very useful compounds that have a wide range of applications. It is known that different monomers allow the customization of properties of the polymer to suit the intended end use. A particular property that is very useful is that of hydrophobicity. A polymer with hydrophobic properties repels water and thus finds great use whenever this property is desired. This type of polymer is particularly useful as a coating, especially if it can be sprayed on.

The most common method of adding hydrophobicity to a surface is the use of waxes. Stains and other coatings often incorporate a wax to increase the surface tension of water. The disadvantages are the possible adverse effect on the adhesion, short service life due to oxidation and the relative ease of removal, either by mechanical means or through washing and leaching if incorporated into a coating. This method would not be suitable for a low-drag marine coating. Another method is the use of PTFE polymer or incorporation of PTFE polymers into the coating. The use of PTFE is prohibitive in most coatings applications.

U.S. Pat. No. 3,936,409 describes the synthesis of urea urethanes that can be used to protect various substrates from water, but these polymers do not have substantial hydrophobicity for many applications. U.S. Pat. No. 3,936,409 is hereby incorporated by reference.

What is badly needed is a polymer that can be made cheaply and can possibly be sprayed on to form a water repellant coating.

### SUMMARY OF THE INVENTION

The present invention relates to a hydrophobic polymer made by incorporating alkyl chains pendant to the main backbone of the polymer. Alkyl chains of from about 6 to over 22 carbons are present in fatty compounds well known in the art. The present invention allows creating polymers with these alkyl chains pendant to the polymer chain. It is well known that synthetic and naturally derived starting materials such as tallow diamine or ethoxylated tallow amine typically contain a mixture of chain lengths with varying degrees of branching and unsaturation. The unsaturated positions in the final polymer can be made to cross-link in the presence of a catalyst to increase the hardness and reduce the effect of heat and solvent borne exposures.

The present invention can be a replacement to current monomers or additive to common polymers to replace or modify the current polymers to alter the properties of a polymer. The present invention adds the known benefits of fatty compounds to common polymers such as hydrophobicity, or in altering the HLB (hydrophilic lipophilic balance) of polymeric surfactants.

The present invention is directed primarily to urea and urethane polymers, but can be useful in the incorporation of pendant alkyl structures in other types of polymers that use an amine or alcohol groups to form the linkage. Other polymer types which can utilize this invention include, but are not limited to the following: polyamide, polyester, polycarbonate, polyether, polysiloxane, and epoxy.

### DESCRIPTION OF THE FIGURES

Attention is now drawn to several figures which aid in understanding the present invention.

FIG. 1: Shows the process for making a polyurea with a pendant fatty chain.

FIG. 2: Shows the process for making a polyurethane with a pendant fatty chain.

FIG. 3: Shows the process for making several types of polymers with fatty pendant chains using a fatty acid and polyol as starting materials.

FIG. 4: Shows the process for making polymers with fatty pendant chains using a fatty acid and diethanolamine as starting materials.

FIG. 5: Shows the process for making polymers with fatty pendant chains using a fatty acid and diethylene triamine (DETA).

### DETAILED DESCRIPTION OF THE INVENTION

It is well known in the art to combine polyols or polyol pre-polymers with organic isocyanates and other materials to form polymers and polymeric resins. In particular, paints and coatings often contain polyurethane or other polymeric coating materials derived from an amine or alcohol functional monomer. A generic urethane has the following structure:

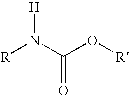

It is well known in the art that R and R′ can be the same or different. A typical polyurethane polymer is made up of chains of the form:

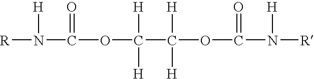

or of the form:

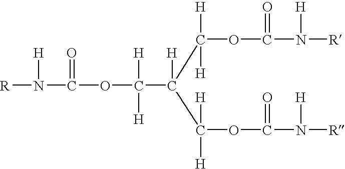

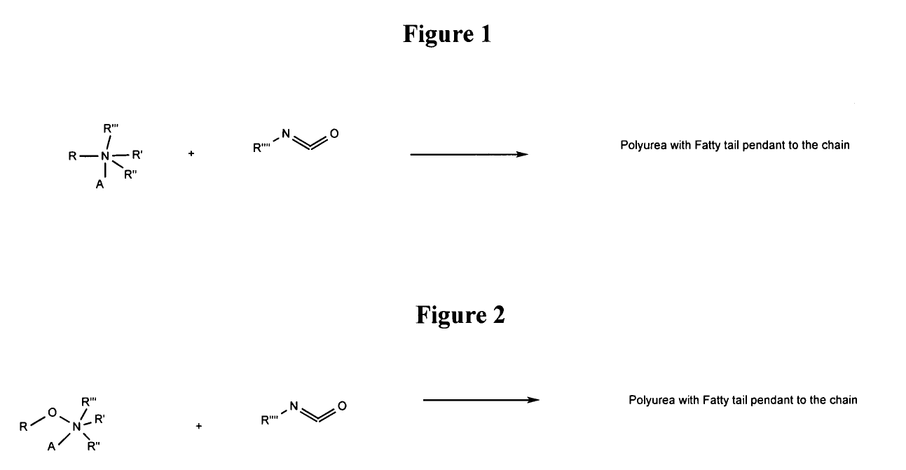

Multifunctional fatty compounds, such as polyamines or ethoxylated amines, can be reacted with isocyantes to form polymers or pre-polymers that have uses in coatings, films, fibers, or structural components. In particular, ethoxylated fatty acids can be combined with organic isocyanates to form polyurethane type polymers. The resulting polymer contains fatty chains that are covalently bonded pendant to the backbone of the polymer. Ethoxylated fatty acids and fatty diamines or similar compounds containing multiple isocyanate cross-linkable moieties can be mixed, with or without the aid of a co-solvent, with the polyol component of commercially available two-component systems to the extent they are soluble. In the case of polyurethane, the linked moiety is similar to that shown in FIG. 1.

FIG. 1. Shows synthesis of a typical polymer of the type described by this invention. R may be any alkyl or alkoxy group of between around 6 to around 22 carbons. R′ and R″ can be the same or different, chosen from a wide range of materials, including, but limited to, H, —(CH2)ₙH, —(CH2)ₙNH2, —[(CH2)ₙNH]ₘ(CH2)ₒ]NH2, with n, m and o from 1 to 30, —(CH2CH2O)ₐ— (CH2CH(CH3)O)_{b}—(CH2CH(CH2CH3)O)_{c}H with a, b, and c integers from 0 to 30, —(CH2)ₓH with x from 1-30, —(CH2)ₙN[(CH2CH2O)ₐ— (CH2CH(CH3)O)_{b}—(CH2CH(CH2CH3)O)CH]—(CH2CH2O)ₐ—(CH2CH(CH3)O)_{b}—(CH2CH(CH2CH3)O)ₙH, —[(CH2)ₙN(CH2CH2O)ₐ—(CH2CH(CH3)O)_{b}—(CH2CH(CH2CH3)O)_{c}H]ₘ(CH2)ₒ]N[(CH2CH2O)ₐ—(CH2CH(CH3)O)_{b}—(CH2CH(CH2CH3)O)_{c}H]—(CH2CH2O)ₐ—(CH2CH(CH3)O)_{b}—(CH2CH(CH2CH3)O)_{c}H. Together R′ and R″ must contain a total of at least two terminal —NH₂ or —OH or a combination of either totaling at least two. The use of alkoxylated polyamines (at least three terminal —OH groups are present) as included above, produces polymers with tertiary cross linking when reacted with diisocyanates as opposed to the linear structures that result from diisocyanates and alkoxylated primary amines. Another way to achieve tertiary cross linking is to utilize a polyisocyanate that has more than two isocyanate groups available for the urea/urethane reaction.

Quaternary alkoxy amines are produced from alkoxylated amines, and contain at least two terminal —OH groups, such as the Tomah Q-series, and can be polymerized in the same manner as alkylated amines.

Another embodiment of the invention is the use of fatty ether polyamines or ethoxylated fatty ether amines. FIG. 2 Describes the case in which the fatty moiety is an alkoxy group.

A typical example of an embodiment of the invention is to combine, for example, an ethoxylated amine with a polyisocyanate. By varying the reactants, various hardnesses and flexibilities can be achieved. By varying the type of isocyanate used, the speed of cure can be adjusted. By changing the functionality of the alkyl containing component, different properties can be achieved.

It is an object of the present invention to create a class of hydrophobic urethane and urea polymers with alkyl side chains pendant to the main polymer backbone.

It is another object of the present invention to provide a way to control cross-linking in a hydrophobic polymer by controlling the amount of unsaturation present in pendant side chains.

It is another object of the present invention to provide a way to control cross-linking in a hydrophobic polymer by controlling the number amine groups or alcohol groups in the polyamine/alkoxylated amine reactant utilized.

It is another object of the present invention to provide a way to control cross-linking in a hydrophobic polymer by controlling the number of isocyanates groups present in the polyisocyanate.

It is still another object of the present invention to provide a method of making low cost sprayable hydrophobic polymeric coatings.

The preferred embodiment of the present invention is primarily directed toward polyurethane and polyurea structures, but other embodiments can include the incorporation of pendant alkyl structures in other types of polymers that use an amine, carboxylic acid or alcohol group to form the linkage. Other polymer types which can utilize this invention include, but are not limited to, the following: polyamide, polyester, polycarbonate, polyether, polysiloxane, and epoxy.

The presence of pendant saturated or partially unsaturated fatty chains causes the resulting polymers to have hydrophobic and other desirable properties such as the ability to control the amount of final cross-linking between backbones and the pendant chains.

Another application of the invention is the use in water-proof or water resistant, semi-permeable materials. This is achieved by processing the material of the invention in such a way that it contains pores of a size that are larger than that of water vapor, and smaller than a water droplet, roughly on the order of roughly 90 microns in diameter. Processing can be achieved in many ways, including but limited to, molding, extrusion, sintering, and via air bubble formation during the synthesis reaction. The inclusion of these pores allow for the passage of water vapor through the film, while the pores are too small for water droplets to pass through. The hydrophobic nature of the material prevents wicking. Thus, an effective water barrier that allows water vapor to pass through.

Alternatively, by controlling the cross-link density of the polymeric material as described in the invention, a matrix can be achieved with the desired permeability. This utilizes the same principles as used in the manufacture of polyacrylamide gels that are used in PAGE electrophoresis for separating proteins of various sizes. The use of varying carbon chain lengths of the starting materials and, in the case of alkoxylated starting materials, the amount of alkoxylation, the properties of the final film can be adjusted to meet the various needs of the final application, such as strength and flexibility. A typical application of the invention would be in the manufacture of water-proof, breathable clothing.

By controlling the cross link density and hydrophobicity as described in the invention, other materials could also be separated. This would provide a means of separating materials from water or other solvents. Other gas phase separations are also within the scope of the invention.

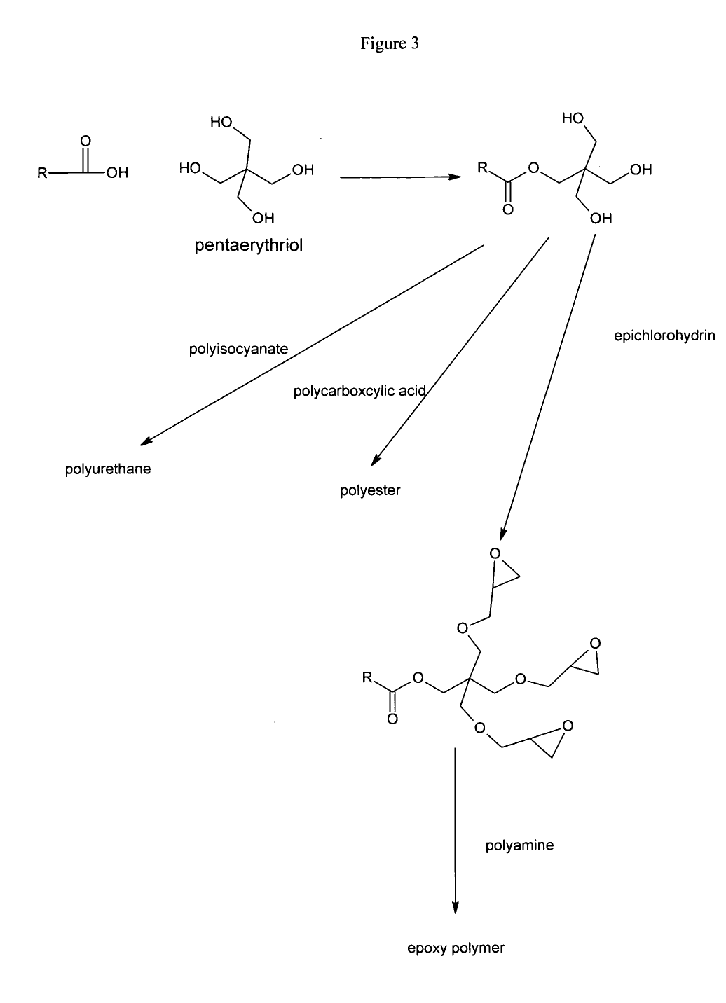

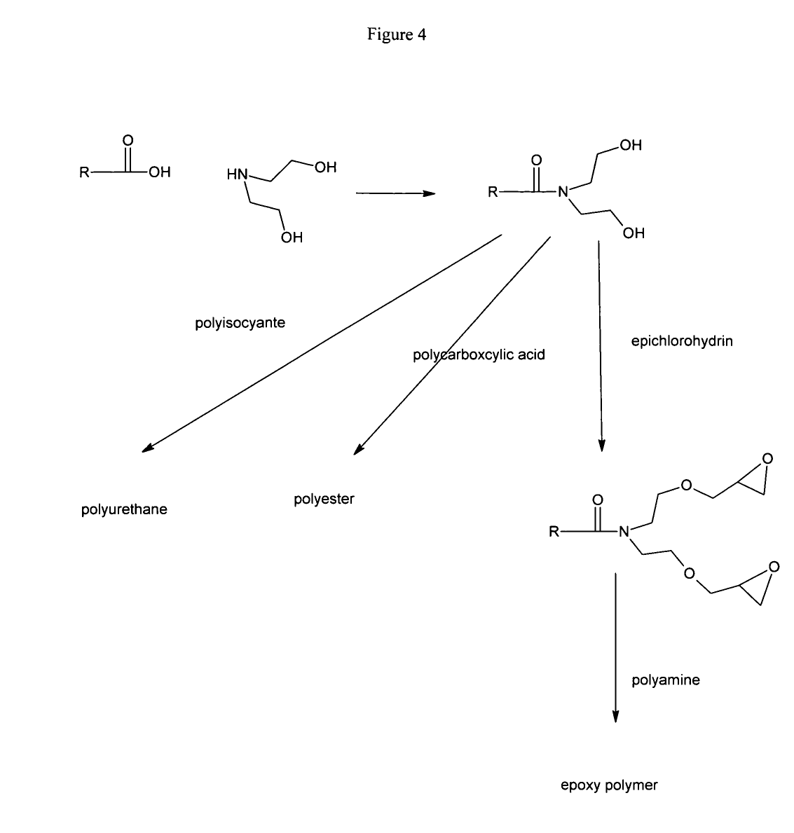

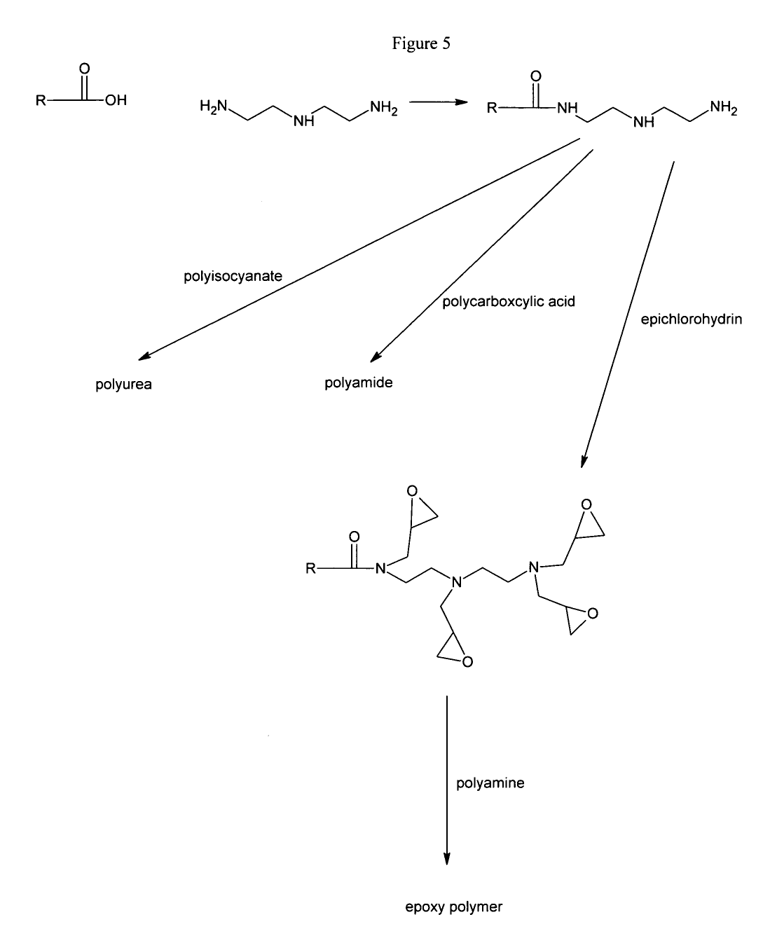

FIG. 3 shows how similar polymers with pendant fatty chains may be reached by reacting fatty carboxylic acids, which are typically carboxylic acids with greater than 6 carbon atoms, with polyols including, but not limited to, trimethylol propane or pentaerythrol. The resulting polyol can then enter into the same types of polymerization reactions as the ethoxylated amines. If polyols with more than three hydroxyls are used, the resulting product can be used to increase tertiary cross link density, giving greater rigidity, or additional moles of a fatty carboxylic acid can be reacted to give greater hydrophobicity. Similarly, ethylene amines, such as diethanolamine, can be used as starting materials with fatty carboxylic acids to form the amide that has multiple hydroxyl groups, as shown in FIG. 4. In the case of triethanolamine, the carboxylic acid forms an ester linkage and again, a polyol that can be polymerized similarly to the ethoxylated amines described above. Alternatively, fatty amines can be reacted with carboxylic acid functional polyols. Fatty amines can be reacted with polycarboxylic acids, so long as the number of carboxylic acid groups is three or greater, to form polycarboxylic functional amides. These polycarboxylic amides can then be reacted with a variety of polyols, including, but not limited to those described herein, to form hydrophobic polyesters. Another embodiment is to react polyamines, such as DETA (diethylenetriamine) and TETA (triethylenetriamine), with fatty carboxylic acids to yield a starting material that can then enter into reactions similar to the polyamines with pendant fatty chains, such as is shown in FIG. 5. It is worth noting that in the case of polyamines where more than three amine groups are present, the amide nitrogen need not be reacted with epichlorohydrin to form a stable epoxy adduct. The above products can all then be reacted with isocyanates, polycarboxylic acids (including carboxylic acid anhydrides), epoxides, etc. to form hydrophobic polymers that can be used in all the applications described herein.

### EXAMPLES

### Example 1

8 g of Tomah E-17-5 (poly (5) oxyethylene isotridecyloxypropylamine) was added to 10 g of Bayer Mondur E744 (pre-poly of diphenylmethane 4,4′-diisocyanate). The resulting tack free solid showed typical polymeric properties as it reacted. During the reaction, a highly fibrous and ordered plastic could be pulled from the vessel. The product liberated heat and foamed during the reaction as well.

### Example 2

6 g of Tomah E-17-2 (poly (2) oxyethylene isotridecyloxypropylamine) was added to 10 g of Bayer Mondur E744 (pre-poly of diphenylmethane 4,4′-diisocyanate). The resulting tack free solid showed typical polymeric properties as it reacted. During the reaction, a highly fibrous and ordered plastic could be pulled from the vessel. The product liberated heat, but foamed less than than Example 1. In a repeat of the reaction, the addition FB100 reduced foam substantially and resulted in a product that is much better suited to be a coating.

### Example 3

6 g of Tomah E-17-5 (poly (2) oxyethylene isotridecyloxypropylamine) was added to 10 g of Bayer Mondur N3200 (pre-poly of hexamethylene diisocyanate) and 0.5 g FB100 butyrate antifoam. The resulting tack free solid showed typical polymeric properties as it reacted. During the reaction, a highly fibrous and ordered plastic could be pulled from the vessel. The product reacted much slower than EXAMPLE 2 and foamed much less. This product was suitable as a coating or cast product.

### Example 4

4.3 g Tomah Q-17-5PG (74% active isotridecyloxypropyl poly (5) oxyethylene in propylene Glycol) were added to 10 g of Bayer Mondur E 744 (pre-poly of diphenylmethane 4,4′-diisocyanate). This reaction occurred very slowly with very little visible foaming. The material did form a translucent tack free solid after eight hours.

### Example 5

5.5 g of Crison Crisamine PC-2 (poly (2) oxyethylene primary cocoamine) was added to 10 g of Bayer Mondur E744 (pre-poly of diphenylmethane 4,4′-diisocyanate). The resulting tack free solid showed typical polymeric properties as it reacted. During the reaction, a highly fibrous and ordered plastic could be pulled from the vessel. The product liberated heat and foamed during the reaction but the addition of FB100 butyric antifoam helped reduce this. This material was optically clear. A slight reduction in Bayer Mindur E744 yielded a very soft flexible tack free material.

### Example 6

7 g of Crison Crisamine DC (cocodiamine) dissolved in 40 g of a 50:50 mixture of naphtha and acetone was added to 10 g of Bayer Mondur N3200 (pre-poly of hexamethylene diisocyanate). The products reacted very quickly, even with the solvent present and the aliphatic isocyanate. A tack free rubbery solid formed.

### Example 9

12 g of Tomah DA-17 (Isotridecyloxypropyl-1,3-diaminopropane) was added 10 g to Bayer Mondur N3200 (pre-poly of hexamethylene diisocyanate) in 40 g of naphtha. The reaction was almost instantaneous, white strands formed immediately upon contact and a tack free stringy mass resulted after the solvent was evaporated.

### Example 10

10 g of Crison Crisamine PC-2 (poly (2) oxyethylene primary cocoamine) was added to 5.8 g of Bayer Desmodur H (hexamethylene diisocyanate, HDI). The resulting tack free solid had a straw color, but good clarity and moderate to high stiffness with essentially no foaming.

### Example 11

10 g of Crison Crisamine PC-2 (poly (2) oxyethylene primary cocoamine) was combined with 10 g of Crison Crisamine DT-3 (Tris(2-hydroxyethyl)-N-tallowalkyl-1,3-diaminopropane) before being added to 12.9 g of Bayer Desmodur H (hexamethylene diisocyanate, HDI). The resulting material formed a tack free solid more quickly than Example 10. The resulting solid was very elastic with good clarity and essentially no foaming.

I claim:

1) Hydrophobic polymer or co-polymer of the following structure: 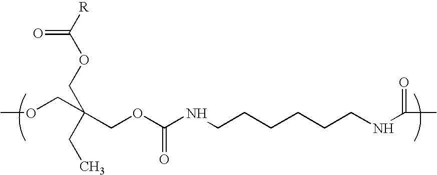
Where R is a saturated or unsaturated, branched or linear alkyl group with from 5 to 22 carbons.

2) The invention of claim 1 where R is linear and saturated and 17 carbons.

3) The invention of claim 1 where R is linear and saturated and 9 carbons.

4) The invention of claim 1 where R is linear and saturated and 11 carbons.
